(19) United States
(12) Patent Application Publication
(10) Pub. No.: US 2006/0037720 A1
(43) Pub. Date: Feb. 23, 2006

(54) Brake mechanism for curtain linkage system

(76) Inventor: Shien-Te Huang, Taipei (TW)

Correspondence Address: Shien-Te Huang, P.O. Box No. 6-57, Junghe, Taipei, 235, TW

(21) Appl. No.: 10/921,179

(22) Filed: Aug. 19, 2004

(51) Int. Cl. E06B 9/30

(52) U.S. Cl. 160/171

(57) ABSTRACT

A brake mechanism for curtain linkage system, which provides an improved mechanism for application in a curtain set such that when curtain slats are subjected to external forces that produce a counterforce, the counterforce is utilized to achieve a reverse braking effect. The brake mechanism can outwardly transmit motive power inputted to a drive unit to a connected linkage shaft. More specifically, the brake mechanism comprises a shield-shaped rotor disposed interior of a circular box. A confining ring is configured on a periphery of the circular box, and a rolling pin is configured between an inner circumference of the confining ring and a rotor, and the rolling pin functions to effectuate a shearing effect. Relative motion of the rolling pin and the rotor realizes a reverse braking effect in the confining ring, and which successfully achieves functionality of the brake mechanism of the present invention.

### BACKGROUND OF THE INVENTION

(a) Field of the Invention

The present invention relates to a brake mechanism for curtain linkage system, and more particularly to an improved mechanism for application in a curtain set such that when curtain slats are subjected to external forces that are transmitted back to a transmission mechanism, the forces are utilized to realize a braking effect. The brake mechanism of the present invention primarily comprises a shield-shaped rotor, and after inter-configuring a rolling pin, am immobile periphery confining ring functions as basis to effectuate the braking effect.

The rotor is disposedly contained in a circular box, and the rolling pin is subjected to synchronous rotation about a same angular position along with rotational displacement of the circular box.

(b) Description of the Prior Art

Regarding necessity for configuring a brake mechanism in a curtain linkage system, during course of actuating release of curtain slats or at the moment of implementing opening of the curtain slats, the curtain slats are subjected to external force effects such as air currents, wind pressure, and so on, which effectuate a reverse transmission to a drive unit, bringing about deformation in shade surfaces or deviation in angle of the shade surfaces.

Referring to FIG. 1, which shows a curtain set 5 primarily comprising a top rail 51, which connects to a bottom rail through curtain slats 53 that are linked together by means of a ladder cord 55.

The ladder cord 55 winds round a cord-winding spool 52. The cord winding spool 52 and an angular transmission rod 50 are assembled so as to form a take-up and release device 520. The angular transmission rod 50 is driven by a drive unit 2, which generates motive power to actuate the curtain slats 53.

Upon the curtain slats 53 being subjected to external force effects, the force effects on the curtain slats 53 are transmitted to the cord-winding spool 52 through the ladder cord 55, and the cord-winding spool 52 thereupon indirectly effectuates the reverse transmission to the drive unit 2 through the angular transmission rod 50.

In order to prevent change in shading effect of the curtain slats 53, and ensure safety of the drive unit 2, a brake mechanism 1 is indirectly connected between the drive unit 2 and the angular transmission rod 50. The brake mechanism 1 is thus able to utilize a reverse acting force of the reverse transmission from the angular transmission rod 50 and effectuate a brake effect therewith.

Correspondingly, the brake mechanism 1 can outwardly transmit motive power inputted to the drive unit 2, and thereon to the angular transmission rod 50.

Prior patents related to the brake mechanism 1 include U.S. Pat. No. 4,372,432, which utilizes variance in a spring to effectuate a brake effect on related shafts, and applies a reverse transmitted force from an angular transmission rod to initially actuate deformation of the spring, which alters an internal diameter of the spring, and therewith actuates a corresponding effect on related shafts of a drive unit.

However, because the brake effect is effectuated by means of the variance in the internal diameter of the spring, when the variance exceeds a bound critical point, slippage results as a consequence.

Another prior patent is Taiwan patent No. 87204310, as depicted in FIG. 2, which is assembled so as to enable utilizing a cross-shaped rotor 12, central of which is configured a shaped hole 120 that provides for outwardly transmitting motive power to a linkage shaft 20.

Stopping grooves 121 and shearing grooves 122 are configured on the rotor 12 at a 90-degree angle to each other. A confining ring 11 for external connections is configured exterior of the rotor 12. A turntable 14 is configured on one side of the drive unit 2, and transversal embed slots 141 are defined interior of the turntable 14 in a cross direction. Two arc-shaped shearing members 142 are configured so as to separately extend from the turntable 14.

Single ends of rolling pins 13 separately insert into the embed slots 141, and the drive unit 2 is adopted to be actuated manually or electrically.

Accordingly, the arc-shaped members 142 configured on the turntable 14 are adapted so as to take up position in the stopping grooves 121 of the rotor 12, and therewith effectuates rotating of the rotor 12 through actuating of the drive unit 2.

Upon the linkage shaft 20 generating the reverse acting force, the rotor 12 is initially actuated, whereupon flat surfaces in a bottom of the shearing grooves 122 configured in the rotor 12 first shear press the rolling pins 13. Because the rolling pins 13 are movably disposed in the embed slots 141, thus the rolling pins 13 are subjected to directional limiting guidance by the embed slots 141, and will outwardly extend to press on an inner circumferential surface of the confining ring 11, thereupon achieving objective of forming a reverse brake effect.

Referring to FIG. 2, which shows the brake effect of a conventional brake mechanism, whereby complete locking is achieved mechanically, however, one shortcoming is in length of component members, wherein, with respect to specific length requirements of the rolling pins 13, length of each component member must be accordingly relatively longer. Hence, after assemblage of the entire brake mechanism 1, space dimensions must be enlarged to accommodate assembling of related components.

In addition, only the single ends of the rolling pins 13 are inserted into the embed slots 141, which thereby allows another end of each of the rolling pins 13 to freely move, and on initial motive power actuating the rotor 12, if there exists a slight bias, then the free ends of the rolling pins 13 will generate oblique offsets, resulting in jamming of the component members

Furthermore, each component member must be produced by a particular manufacturing method, for instance, powder metallurgy manufacturing method. However, because quality of the powder metallurgy method is prone to fragmentation, thus production of the component members necessarily employs an alloy material in order to avoid fragmentation, and even further procedures must be implemented that increase costs.

The turntable 14 and the confining ring 11 are necessarily configured in conjunction with other related component members, and only then can a functional module be assembled. For instance, the rotor 12 is necessarily subjected to axial pushing contact by the linkage shaft 20, and only then can the rotor 12 take position in the inner circumferential position of the confining ring 11, which can result in coming away of the linkage shaft 20, and thus easy falling off of the rotor 12.

Correspondingly, the rolling pins 13 are similarly necessarily effectuated by shearing from other component members, and only then can the rolling pins 13 take position in the embed slots 141.

### SUMMARY OF THE INVENTION

In light of the aforementioned shortcomings, the present invention particularly improves upon a brake mechanism, and achieves simplification, ease of manufacture, and facilitation in assembly workflow.

The brake mechanism for curtain linkage system of the present invention primarily utilizes a circular box, interior of which is disposed a shield-shaped rotor.

A confining ring is configured on a periphery of the circular box, and a rolling pin is configured between an inner circumference of a confining ring and a rotor, and the rolling pin functions to effectuate a shearing effect. Relative motion of the rolling pin and the rotor effectively achieves objective of a reverse braking effect.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an assembled schematic view of a curtain set.

FIG. 2 shows an exploded elevational view of related component members of a conventional brake mechanism.

FIG. 3 shows an exploded elevational view of related component members according to the present invention.

FIG. 4 shows a side view of FIG. 3 after assemblage according to the present invention.

FIG. 5 shows a front view of FIG. 3 after assemblage of primary working component members according to the present invention.

FIG. 6 shows a front motion view of a brake mechanism according to the present invention.

FIG. 7 shows a front motion view of a linkage motion principle according to the present invention.

FIG. 8 shows a side view of a composite drive unit according to the present invention.

FIG. 9 shows an exploded elevational view of an inter-configured gear set according to the present invention.

FIG. 10 shows another embodiment having a related extensible device according to the present invention.

### DETAILED DESCRIPTION OF THE PREFERRED EMBODIMENTS

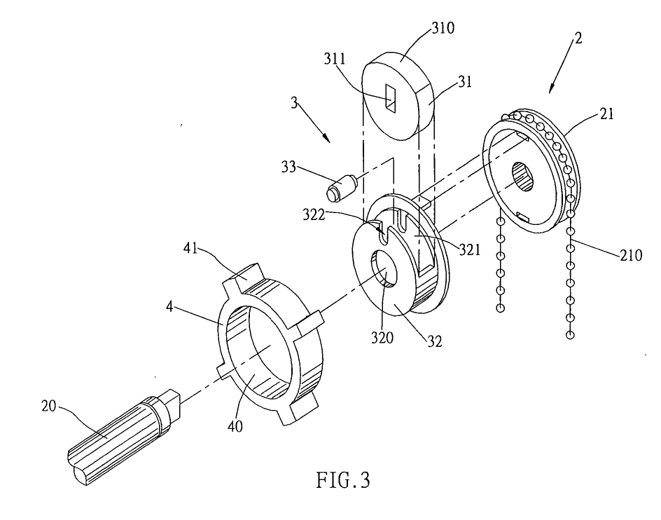

Referring to FIG. 3, which shows the present invention primarily comprising a drive unit 2 that actuates a brake mechanism 3, which is further coupled to a linkage shaft 20, and entire structural configuration of such is installed as part of a power mechanism in the aforementioned top rail of a curtain set.

The drive unit 2 synchronously rotates a circular box 32 of the brake mechanism 3 through a sprocket wheel 21, which is actuated by means of a beaded chain 210.

A section between the sprocket wheel 21 and the box 32 functions as an independent component, and a connected body of such is assembled by means of a socket joint or a single body can be formed by ejaculation.

A through hole 320 is frontward configured in the circular box 32, and an interior of the box 32 is adapted so as to form a circular slot 321, which provides for a shield-shaped rotor 31 to be disposed therein. An insertion hole 311 is defined center of the shield-shaped rotor 31, which provides for the linkage shaft 20 to link therein. One side of the rotor 31 is configured so as to form a shear press surface 310.

A periphery of the box 32 is disposedly sheathed into an inner circumference 40 of the confining ring 4. A periphery of the confining ring 4 is fixedly secured to the aforementioned top rail by means of card blocks 41, thereby forming a secure fitting therewith.

A rolling pin 33 is configured relative between the shear press surface 310 configured on the rotor 31 and the inner circumference 40 configured in the confining ring 40. The rolling pin 33 is subjected to a radial displacement range within shearing slots 322 configured in the box 32. Furthermore, the rolling pin 33 is further actuated about a same angular position by rotation of the box 32.

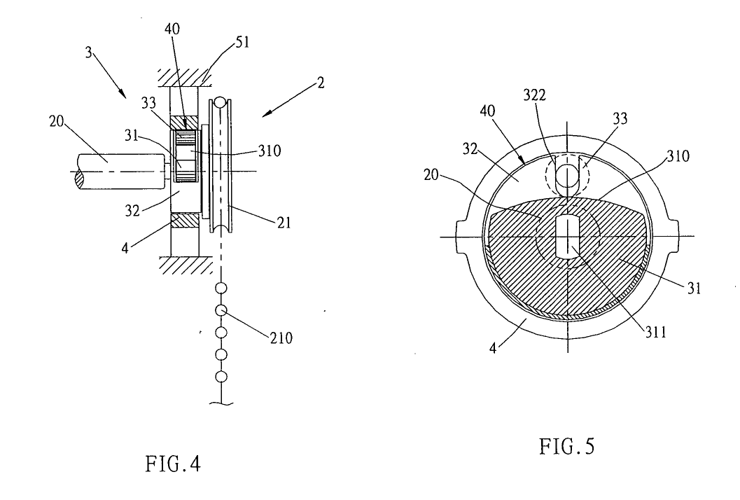

Referring to FIG. 4, which shows a side view of the entire configuration after assemblage, wherein after actuation of the sprocket wheel 21 configured on the drive unit 2 by means of the beaded chain 210, the circular box 32 is thereby synchronously actuated. The periphery of the circular box 32 being disposedly sheathed in the inner circumference 40 of the confining ring 4 thereby produces circular relative motion.

The rotor 31 is disposedly contained interior of the circular box 32. The shear press surface 310 atop the rotor 31 indirectly affects the inner circumference 40 of the confining ring 4 through the rolling pin 33.

Center of the rotor 31 outwardly links to the linkage shaft 20, and thus motive power from the bridging drive unit 2 is outwardly transmitted through the linkage shaft 20.

Referring to FIG. 5, which shows the aforementioned rotor 31 producing a relative effect in the inner circumference 40 of the confining ring 4 by means of the rolling pin 33 (FIG. 5 depicts a front view after assemblage, wherein only primary mobile members are shown in order to simplify the figure).

The insertion hole 311 configured in the center of the rotor 31 is outwardly socket jointed to the linkage shaft 20

The box 32 is subjected to actuation from linkage to the drive unit 2 (see FIG. 3).

The rolling pin 33 is subjected to the radial displacement range within the shearing slots 322 configured in the box 32. Furthermore, the rolling pin 33 is synchronously subjected to rotation by the shearing slots 322, while the confining ring 4 maintains an immobile state.

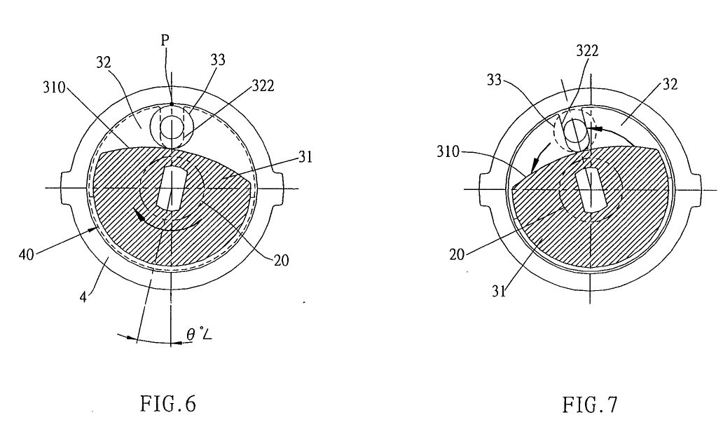

Referring to FIG. 6, which shows a motion view of a principle behind the reverse brake mechanism 3. The confining ring 4 maintains an immobile state, and because the box 32 is not subjected to rotation, the box 32 is thus also in an immobile state, while the rolling pin 33 being subjected to the radial displacement range within the shearing slots 322 is only able to radially displace within the shearing slots 322.

Upon the rotor 31 being subjected to reverse clockwise motion, then a left side of the shear press surface 310 actuates a corresponding lower circular shearing point of the rolling pin 33, and, moreover, coerces the rolling pin 33 to form radial displacement.

An upper circular shearing point P of the rolling pin 33 thereupon presses to come alongside the inner circumference 40 configured in the confining ring 4, thus realizing formation of a stopping effect on the rotor 31, and further stops the linkage shaft 20, which thereby achieves objective of a braking effect.

Referring to FIG. 7, which relates to output linkage relationships, wherein when the box 32 is subjected to anticlockwise driving of the aforementioned drive unit 2, then the shearing slots 322 are synchronously actuated into rotation, which thereby re-actuate the rolling pin 33 therewith.

Whereupon, the lower shearing point of the rolling pin 33 presses the shear press surface 310 configured on the rotor 31, which thus effectuates codirectional rotation of the rotor 31. After the rotor 31 has been successfully actuated to rotate by the box 32, the linkage shaft 20 is thereupon synchronously actuated, and which generates power output therefrom.

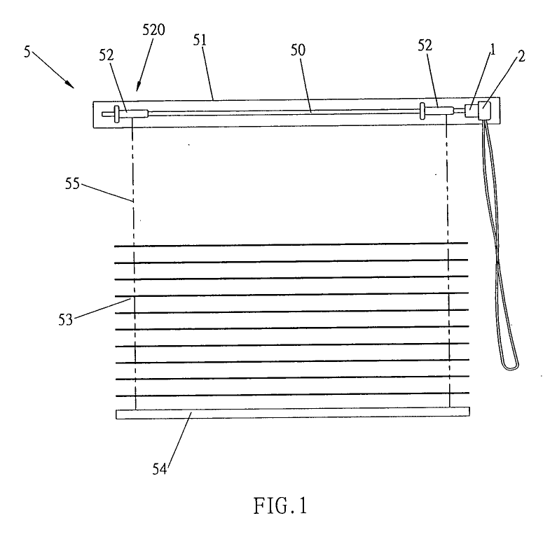

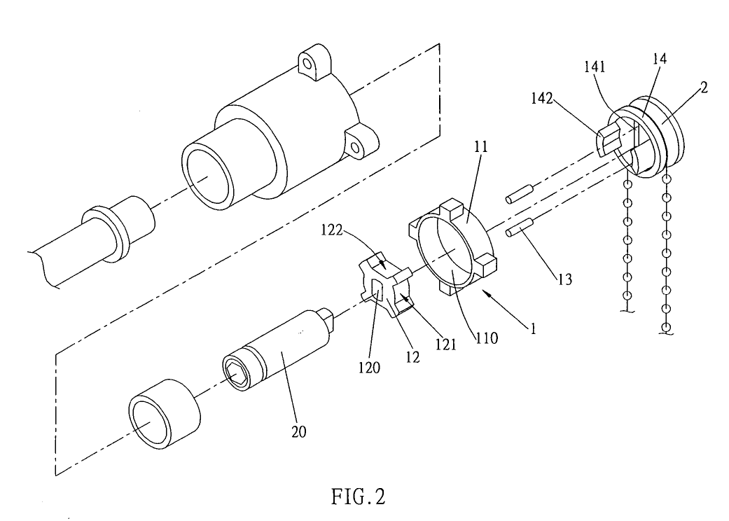

With reference to the aforementioned descriptions of FIGS. 6 and 7, it can be understood that If curtain slats 53 of a curtain set 5 (see FIG. 1) are subjected to external force effects, then an acting force can be transmitted to a ladder cord 55, and the ladder cord 55 rewinds round a cord winding spool 52. The cord winding spool 52 and an angular transmission rod 50 form a linkage with the drive unit 2, thus, because of a counterforce from the external force effects causing reverse transmission to the drive unit 2, the indirect brake mechanism 3 as configured in the present invention achieves the braking effect as depicted in FIG. 6, and has a working principle of power output as depicted in FIG. 7. Furthermore, motive power from the drive unit 2 will be successfully indirectly outputted to the linkage shaft 20, and a coaxial connection exists between the linkage shaft 20 and the angular transmission rod 50.

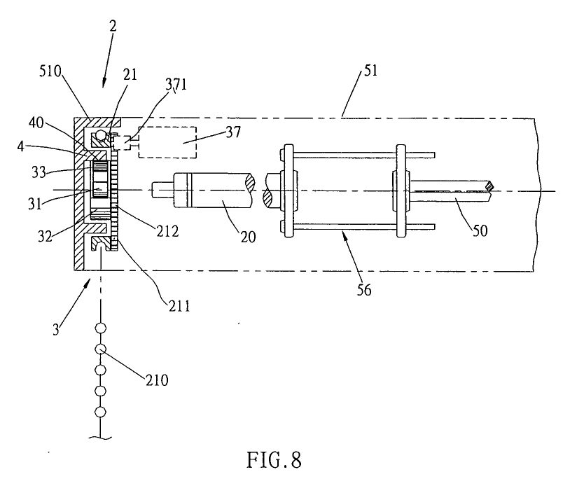

Referring to FIG. 8, in order to lower assembly height of the drive unit 2 and the brake mechanism 3, the drive unit 2 and the brake mechanism 3 can be of a flush composite type.

A seal cover 510 is primary utilized to seal an extremity of a top rail 51, and the confining ring 4 is configuredly connected in alignment with a centerline position. Interior of the confining ring 4 is similarly configured with the inner circumference 40.

The sprocket wheel 21 is mounted interior of the seal cover 510; and the seal cover 510 thereby covering the sprocket wheel 21 therewith. The beaded chain 210 similarly actuates the sprocket wheel 21.

A turntable 211 is mounted on the sprocket wheel 21, and is configured so as to face towards direction of the inner circumference 40 configured in the confining ring 4. The turntable 211 directly connects to the circular box 32. The rotor 31 is similarly moveably disposed interior of the box 32, and the rolling pin 33 is similarly configured between the rotor 31 and the inner circumference 40.

The rotor 31 similarly outwardly coaxially links with the linkage shaft 20, which further outwardly transmits motive power to the angular transmission rod 50 through an extensible device 56.

After the beaded chain 210 actuates the sprocket wheel 21, the sprocket wheel 21 directly transmits motive power to the turntable 211. Whereafter, the turntable 211 synchronously actuates the circular box 32, and the motive power of the turntable 21 is outputted, as depicted in FIG. 7, thereby achieving outwardly transmitting of output power from the linkage shaft 20.

Similarly, because of influence of reverse transmitted motive power from external forces on the angular transmission rod 50, thus the linkage shaft 20 is able to achieve effectuating the braking effect as depicted in a working principle shown in FIG. 6.

In order to achieve an electrical and mechanical control method, an outer ring gear 212 is configured on a periphery of the turntable 211 coupled to the box 32. The outer ring gear 212 provides for a gear 371 configured to an electrical and mechanical motor 37 to mesh therewith. Hence, after actuating the electrical and mechanical motor 37, a torque is amplified through the relatively larger outer ring gear 212 that actuates the circular box 32, and which thereby forms a deceleration effect on the linkage shaft 20.

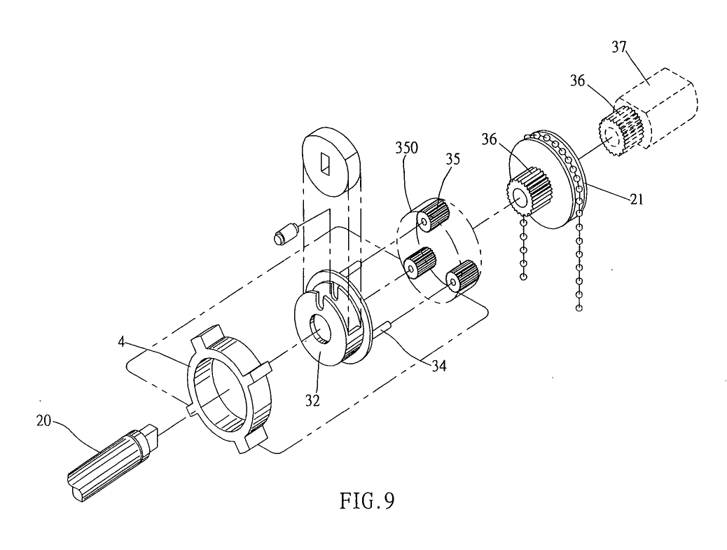

Referring to FIG. 9, which shows the present invention further configured with a gear set within the circular box 32, whereby speed torque conversion can be effectuated between the sprocket wheel 21 and the box 32 by means of the gear set in order to respond to rotating speed conditions.

Wherein, structural configuration of such primarily comprises wheel pins 34 configured on a back end of the circular box 32, and the wheel pins 34 provide for pin connecting to planetary gears 35. An inner ring gear 350 is configured on a periphery of the planetary gears 35, and with which thereby achieves relative meshing of the gears. An immobile state is similarly maintained between the inner ring gear 350 and the confining ring 4.

A sun gear 36 is coupled to a center of the sprocket wheel 21; thereby torque output from the box 32 is enhanced by means of variance in rotating speed of the gear set, which thereby benefits application in large curtains.

The gear set as depicted in FIG. 9 utilizes method of enhancement in torque. However, other gear sets can be adopted that amplify the rotating speed of the gear set, and which can therefore also function as a rotating speed amplification arrangement for the box 32. Structural configurations of such gear arrangements relate to conventional mechanism principles, and thus are not described herein in further detail.

Furthermore, in order to facilitate the electrical and mechanical control, the electric and mechanical motor 37 having a shaft connected to the sun gear 36 can also be configured. Wherein, the electric and mechanical motor 37 is coupled to and thereby actuates the sun gear 36, which thus transmits motive power to the circular box 32 by means of the planetary gears 35, and power transmission to the output linkage shaft 20 is realized.

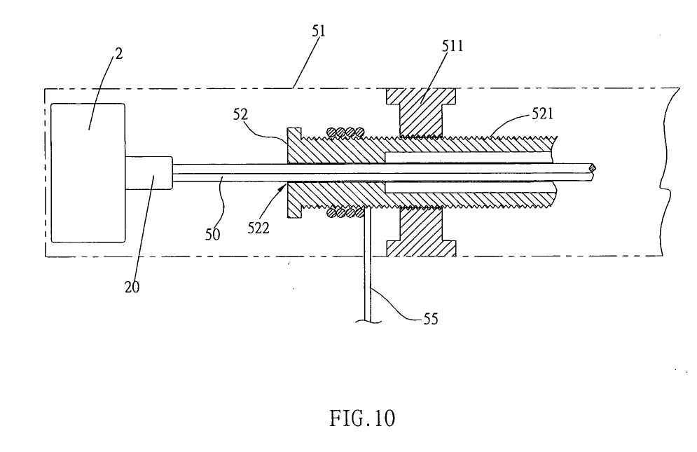

Referring to FIG. 10, which shows motion requirements of the extensible device as depicted in FIG. 8, wherein in order to actualize direct transmission of line of force, a relative helical screw method of operation can be adopted, and which is primarily structured to comprise the drive unit 2 configured on one side of the top rail 51, and motive power therefrom is transmitted to the angular transmission rod 50 directly or by way of the linkage shaft 20. The angular transmission rod 50 actuates a corresponding effect in the angular hole 522 configured in the cord winding spool 52, thereby effectuating radial rotation of the cord winding spool 52 by means of the angular transmission rod 50. A clearance fit between the angular hole 522 and the angular transmission rod 50 is utilized to enable the cord-winding spool 52 to undergo longitudinal displacement, and components correlated to the cord-winding spool 52 thus also undergo longitudinal displacement. In order to utilize helical teeth 521 configured on a periphery of the cord-winding spool 52, a helical seat is fixedly configured to the top rail 51, and which therewith provides for relative meshing with the helical teeth 521 of the cord-winding spool 52. The cord-winding spool 52 is subjected to the radial rotation of the angular transmission rod 50 and the periphery of the cord-winding spool 52 is subjected to a helical meshing action with the helical seat 511. Upon occurrence of clockwise or anticlockwise rotation, the cord-winding spool 52 is thus actuated and thereby rotates, which radially takes up or releases the ladder cord 55. Furthermore, because of slanting transposition formed from meshing between the helical teeth 521 and the helical seat 511, thus the cord-winding spool 52 is able to form a corresponding longitudinal displacement along the angular transmission rod 50. Furthermore, the longitudinal displacement facilitates enhancement in winding the ladder cord 55 round the periphery of the cord winding spool 52, and which enables the ladder cord 55 to uniformly wind round the periphery of the cord winding spool 52 in a sequential manner, thereby forming a sequential distribution of the ladder cord 55. In addition, the ladder cord 55 is able to be fixedly positioned in a through hole 523 defined in the top rail 51, which functions as a fixed point position enabling the ladder cord 55 to pass through without influencing related position variance between curtain slats.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A brake mechanism for curtain linkage system, which achieves a locking effect directed towards a counterforce from a curtain, and comprising a drive unit that actuates a motive effect on a linkage shaft through the brake mechanism, entire structural configuration is installed interior of a top rail of a curtain set, and is characterized in that the brake mechanism comprises a circular box, which is actuated by the drive unit; an interior of the box is adapted so as to form a circular slot, which provides for a shield-shaped rotor having a shear press surface to be moveably disposed therein; a periphery of the box is disposedly sheathed in an inner circumference of an immobile confining ring; center of the rotor outwardly connects to a linkage shaft; a rolling pin is configured relative between the shear press surface configured on the rotor and the inner circumference of the confining ring, moreover, the rolling pin is subjected to displacement and actuation within shearing slots configured in the box.

2. The brake mechanism for curtain linkage system according to claim 1, wherein a section between the box and a sprocket wheel configured on the drive unit can be formed as a single body.

3. The brake mechanism for curtain linkage system according to claim 1, wherein the section between the box and the sprocket wheel configured on the drive unit can be assembled by means of a socket joint.

4. The brake mechanism for curtain linkage system according to claim 1, wherein the section between the drive unit and the box can be further indirectly configured with a speed change gear set.

5. The brake mechanism for curtain linkage system according to claim 1, wherein the drive unit can be adapted to be actuated by a beaded chain.

6. The brake mechanism for curtain linkage system according to claim 1, wherein the drive unit can be adapted to be actuated by an electrical and mechanical motor.

7. A brake mechanism for curtain linkage system, which achieves a locking effect directed towards a counterforce from a curtain, comprising the drive unit that actuates a motive effect on the linkage shaft through the brake mechanism, entire structural configuration is installed interior of the top rail of a curtain set, and is characterized in that the confining ring is integrally configured with a seal cover; the sprocket wheel is compositely configured on a periphery of the confining ring by means of a covering method; a turntable mounted on the sprocket wheel is centrally connected to the box, and the rotor is moveably disposed interior of the box; the rolling pin is moveably disposed relative between the rotor and the confining ring; the rotor is outwardly connected to the linkage shaft.

8. The brake mechanism for curtain linkage system according to claim 7, wherein a periphery of the turntable configured on the drive unit can be adapted to form an outer ring gear, and which is actuated into meshing by the electrical and mechanical motor.
